(19) United States
(12) Patent Application Publication
(10) Pub. No.: US 2026/0112833 A1
(43) Pub. Date: Apr. 23, 2026

(54) POWER CONNECTOR, POWER TERMINAL ASSEMBLY AND CONNECTOR ASSEMBLY

(71) Applicant: OUPIIN Electronic (Kunshan) Co., Ltd, Kunshan City (CN)

(72) Inventor: Hsin Chih CHEN, Kunshan City (CN)

(73) Assignee: OUPIIN Electronic (Kunshan) Co., Ltd, Kunshan City (CN)

(21) Appl. No.: 19/014,294

(22) Filed: Jan. 9, 2025

(30) Foreign Application Priority Data
Oct. 22, 2024 (CN) 202411474473.5
Oct. 22, 2024 (CN) 202422548895.4

(51) Int. Cl. H01R 13/11; H01R 12/71

(52) U.S. Cl. CPC H01R 13/11; H01R 12/716

(57) ABSTRACT

A power connector, a power terminal assembly and a connector assembly are disclosed in this application. The power connector includes an insulation base and at least one power terminal assembly. The power terminal assembly includes a first power terminal and a second power terminal combined together. The first power terminal includes at least one first bent inclined beam and at least one folded straight beam. The second power terminal includes at least one second bent inclined beam. The first and second bent inclined beams construct a pair of clamping beams, and the folded straight beam constructs one insertion beam, thereby providing safe engagement function and stable current conduction capability and improving service life of the power terminal assembly.

### RELATED APPLICATIONS

This application is a Paris Convention, which claims the benefit of priority of Chinese Patent Application No. 202411474473.5 filed on Oct. 22, 2024, and Chinese Patent Application No. 202422548895.4 filed on Oct. 22, 2024. The contents of the above applications are all incorporated by reference as if fully set forth herein in their entirety.

### FIELD AND BACKGROUND OF THE INVENTION

The present application relates to a field of connector technology, and more specifically to a power connector, a power terminal assembly and a connector assembly.

A PwrMAX power connector is very suitable for high-end data, telecommunications and industrial equipment and can provide power services for systems that require high density and high current.

Regarding an existing power connector, please refer to U.S. Pat. No. 7,905,731B2, which discloses an electrical connector with stress distribution features. A contact of the electrical connector includes a first half and a second half. The first half and the second half both have alternating straight contact beams and angled contact beams. When the first half and the second half are combined, the straight contact beam of the first half and the straight contact beam of the second half are combined to a straight contact beam pair, and the angled contact beam of the first half and the angled contact beam of the second half are combined to an angled contact beam pair. When the electrical connector is engaged with another connector, the straight contact beam pair of the electrical connector can be inserted into an angled contact beam pair of the another connector, and a straight contact beam pair of the another connector can be inserted into the angled contact beam pair of the electrical connector.

But in practical situations, if two straight contact beams are combined into the straight contact beam pair, the two straight contact beams need to have high flatness to achieve complete touch. Once one of the two straight contact beams does not have good flatness, a gap will be formed between the two straight contact beams. During insertion, the gap is highly likely to cause the two straight contact beams (i.e. the straight contact beam pair) to fail to align or even fail to insert into a space between the angled contact beam pairs of the another connector, resulting in mating failure. In addition, as long as one of the two straight contact beams does not have good flatness, the straight contact beam pair may deviate from an original mating center and harm the angled contact beam pair. For example, the angled contact beam pair may be asymmetrically opened, which will cause excessive deformation of at least one of the angled contact beams, so that affecting current conduction and connector life.

Hence, it is necessary to provide a new power connector and its power terminal assembly that can provide safe and reliable power services for high-density and high current systems.

### SUMMARY OF THE INVENTION

One object of the present application is to provide a power connector employing a power terminal assembly that has a stable structure and a safe engaging structure for providing stable current conduction capability and improving service life.

Another object of the present application is to provide a power terminal assembly that has a stable structure and a safe engaging structure for providing stable current conduction capability and improving service life.

Further object of the present application is to provide a connector assembly being capable of safely mating and stably transmitting current.

Other objects and advantages of the present application may be further understood from technical features disclosed by the present application.

To achieve the above objects of the present application, the present application adopts the following technical solution.

A power connector comprises an insulation base and at least one power terminal assembly disposed in the insulation base. The power terminal assembly comprises a first power terminal and a second power terminal combined together. The first power terminal comprises a first body with a first mating side, at least one first bent inclined beam disposed on the first mating side, and at least one folded straight beam disposed on the first mating side. The second power terminal comprises a second body with a second mating side and at least one second bent inclined beam disposed on the second mating side. Wherein, the first body and the second body are in parallel touch each other and are fixed together in the insulation base; the first bent inclined beam and the second bent inclined beam are arranged opposite each other to form a pair of clamping beams, and the folded straight beam is used as one insertion beam.

In one embodiment, the folded straight beam has a first straight portion, a second straight portion folded on the first straight portion, and a folded portion connecting the first straight portion and the second straight portion. Wherein, one end of the first straight portion is connected to the first mating side, and the other end of the first straight portion is connected to the folded portion; one end of the second straight portion is connected to the folded portion, and the other end of the second straight portion is a free end.

In one embodiment, a length of the second straight portion is greater than or equal to a length of the first straight portion.

In one embodiment, the second straight portion is provided with a power connection section at a free end of the second straight portion; a thickness of the power connection section is smaller than a thickness of the second straight portion. The second power terminal comprises at least one blank region provided on the second mating side; a blank region is provided with at least one power connection sheet; and a thickness of the power connection sheet is smaller than a thickness of the second body. Wherein, the power connection section faces the power connection sheet. Wherein, when the power terminal assembly is engaged with a mating terminal assembly, the power connection section is connected to the power connection sheet.

To achieve the above objects of the present application, the present application also adopts the following technical solution.

A power terminal assembly comprises a first power terminal and a second power terminal combined together. The first power terminal comprising a first body with a first mating side, at least one first bent inclined beam disposed on the first mating side, and at least one folded straight beam disposed on the first mating side. The second power terminal comprising a second body with a second mating side, at least one second bent inclined beam disposed on the second mating side, and at least one blank region provided on the second mating side. Wherein, the first body and the second body are parallel and touch each other, the first bent inclined beam and the second bent inclined beam are arranged opposite each other to construct a pair of clamping beams, and the folded straight beam is used as one insertion beam. Wherein, the folded straight beam is corresponding to the blank region, and a part of the folded straight beam is accommodated in the blank region.

To achieve the above objects of the present application, the present application also adopts the following technical solution.

A connector assembly comprises a power connector and a mating connector. The power connector comprises an insulation base and at least one power terminal assembly disposed in the insulation base. The mating connector comprises a mating base and at least one mating terminal assembly disposed in the mating base. The power terminal assembly has a first bent inclined beam, a second bent inclined beam and a folded straight beam. Wherein, the first bent inclined beam and the second bent inclined beam are arranged opposite each other to form a pair of clamping beams, while the folded straight beam is used as one insertion beam. The mating terminal assembly has a third bent inclined beam, a fourth bent inclined beam and a folded straight beam. Wherein, the third bent inclined beam and the fourth bent inclined beam are arranged opposite each other to form a pair of clamping beams, while the folded straight beam is used as one insertion beam. Wherein, when the power connector and the mating connector are engaged, the insulation base is engaged with the mating base, the insertion beam of the power terminal assembly is inserted between the pair of clamping beams of the mating terminal assembly to form an electrical connection, and the insertion beam of the mating terminal assembly is inserted between the pair of clamping beams of the power terminal assembly to form an electrical connection, for transmitting power together.

In comparison with the prior art, the power connector and the connector assembly of the present application employ the folded straight beams as the insertion beams in the power terminal assembly and the mating terminal assembly, so that avoiding the risk of unsafe engagement caused by two straight contact beams in the prior art. The connector assembly of the present application has a stable and safe engaging structure, can provide stable current conduction capability and can improve service life. In addition, the power terminal assembly of the present application can connect the first power terminal and the second power terminal by providing a power connection section and a power connection sheet, thereby improving power transmission efficiency.

### BRIEF DESCRIPTION OF DRAWINGS

FIG. 1 is a perspective schematic view of one embodiment of a power connector of the present application;

FIG. 2 is a perspective schematic view of the power connector from another angle;

FIG. 3 is an exploded view of the power connector;

FIG. 4 is a perspective schematic view of one embodiment of a power terminal assembly of the present application;

FIG. 5 is a perspective schematic view of the power terminal assembly of FIG. 4 from another angle;

FIG. 6A is an exploded view of the power terminal assembly of FIG. 4;

FIG. 6B is an exploded view of the power terminal assembly of FIG. 4 from another angle;

FIG. 7A is an exploded view of another embodiment of the power terminal assembly of the present application;

FIG. 7B is a cross-sectional view of the power terminal assembly of FIG. 7A, mainly showing the state of the power terminal assembly before mating;

FIG. 7C is a cross-sectional view of the power terminal assembly of FIG. 7A, mainly showing the state of the power terminal assembly after mating;

FIG. 8 is a perspective schematic view of a mating connector of the present application;

FIG. 9 is a perspective schematic view of the mating connector from another angle;

FIG. 10 is an exploded view of the mating connector;

FIG. 11 is a perspective schematic view of one mating terminal assembly of the present application;

FIG. 12 is a perspective schematic view of the mating terminal assembly from another angle;

FIG. 13 is an exploded view of the mating terminal assembly;

FIG. 14 is a perspective schematic view of a connector assembly of the present application; and

FIG. 15 is a cross-sectional view of the connector assembly, mainly showing the mating state of the power terminal assembly and the mating terminal assembly.

### DESCRIPTION OF SPECIFIC EMBODIMENTS OF THE INVENTION

The following description of every embodiment with reference to the accompanying drawings is used to exemplify a specific embodiment, which may be carried out in the present application. Directional terms mentioned in the present application, such as “top”, “bottom”, “front”, “back”, “left”, “right”, “top”, “bottom” etc., are only used with reference to the orientation of the accompanying drawings. Therefore, the used directional terms are intended to illustrate, but not to limit, the present application.

A connector assembly of the present application includes a power connector and a mating connector, which can be engaged together. The power connector can be referred to as a female connector, and the mating connector can be referred to as a male connector. Of course, the power connector can also be referred to as a male connector, and the mating connector can be referred to as a female connector. Alternatively, without distinguishing between the male and female connectors, the power connector is referred to as a first power connector, while the mating connector is referred to as a second power connector.

The power connector of the present application can solve the problems of engaging failure and excessive deformation of an existing power terminal assembly during mating. The power connector of the present application can provide stable current conduction capability.

The following embodiments illustrate the power connector of the present application using a right angle power connector as an example, with its mating direction parallel to a circuit board. The power connector of the present application can also be an upright power connector, with its mating direction perpendicular to the circuit board. The power connector can also be a power connector at other angles, with its mating direction tilted toward the circuit board.

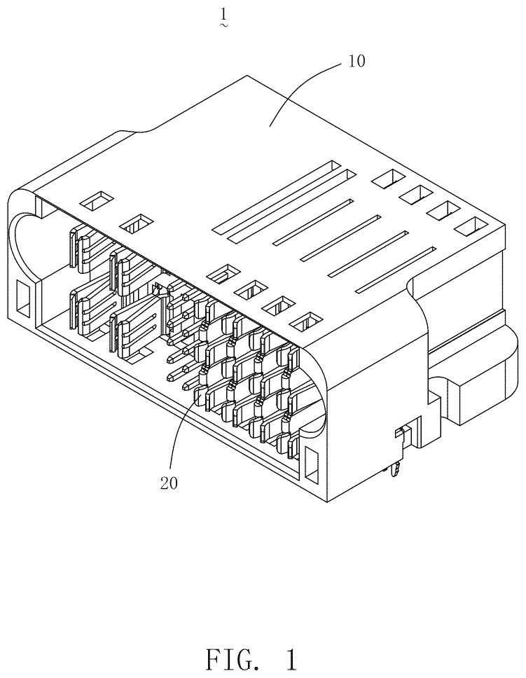

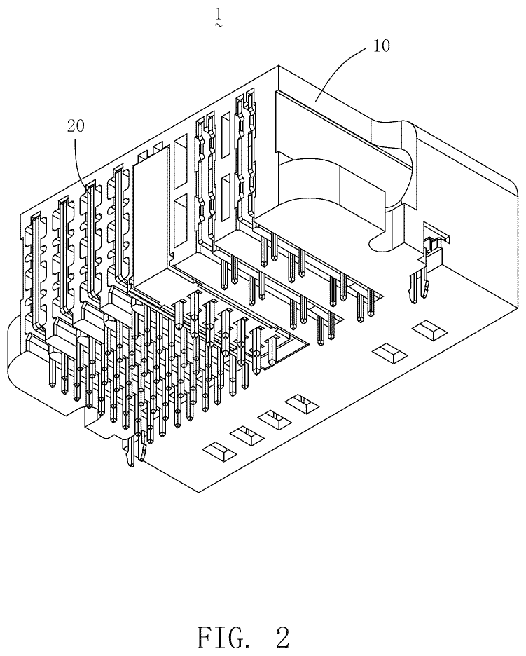

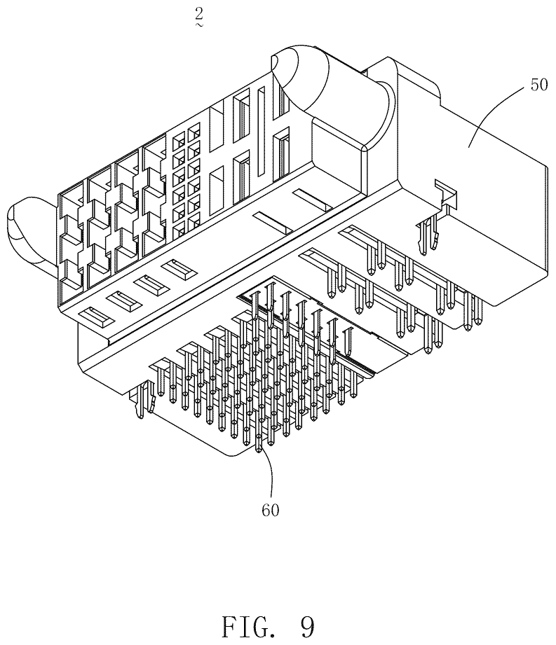

Please refer to FIGS. 1, 2 and 3, the power connector 1 of the present application includes an insulation base 10 and at least one power terminal assembly 20 disposed in the insulation base 10. The power terminal assembly 20 includes a first power terminal 21 and a second power terminal 22 combined together for being engaged with a mating terminal assembly 60 of a mating connector 2 (seen in FIG. 10) to transmit power together.

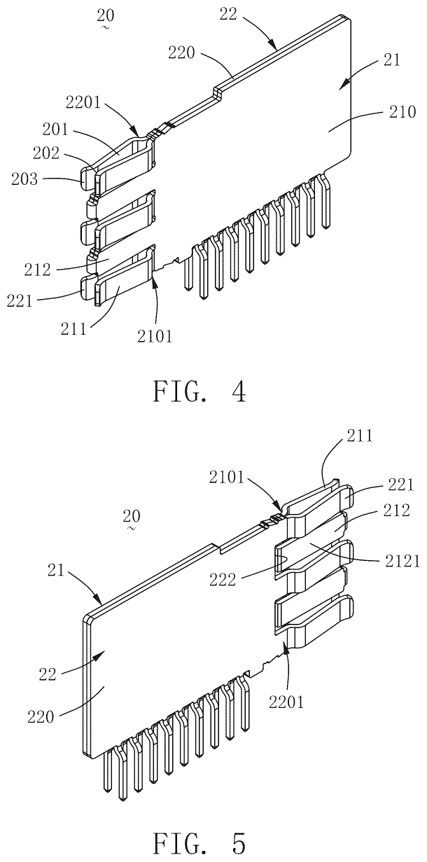

Referring to FIGS. 4, 5, 6A and 6B, the first power terminal 21 includes a first body 210 with a first mating side 2101, at least one first bent inclined beam 211 disposed on the first mating side 2101, and at least one folded straight beam 212 disposed on the first mating side 2101. The second power terminal 22 includes a second body 220 with a second mating side 2201 and at least one second bent inclined beam 221 disposed on the second mating side 2201. Wherein, the first body 210 and the second body 220 are parallel and closely touch each other to be fixed together in the insulation base 10. The first bent inclined beam 211 and the second bent inclined beam 221 are arranged opposite each other to form a pair of clamping beams, while the folded straight beam 212 is used as one insertion beam.

The present application can avoid the risk of unsafe engagement that occurs in the prior art by employing the folded straight beam 212 as the insertion beam in the power terminal assembly. The power terminal assembly 20 and the power connector 1 of the present application have a stable structure and a safe engaging structure for providing stable current conduction capability and improving service life.

The structure and advantages of the power terminal assembly 20 and the power connector 1 of the present application will be described in more detail below.

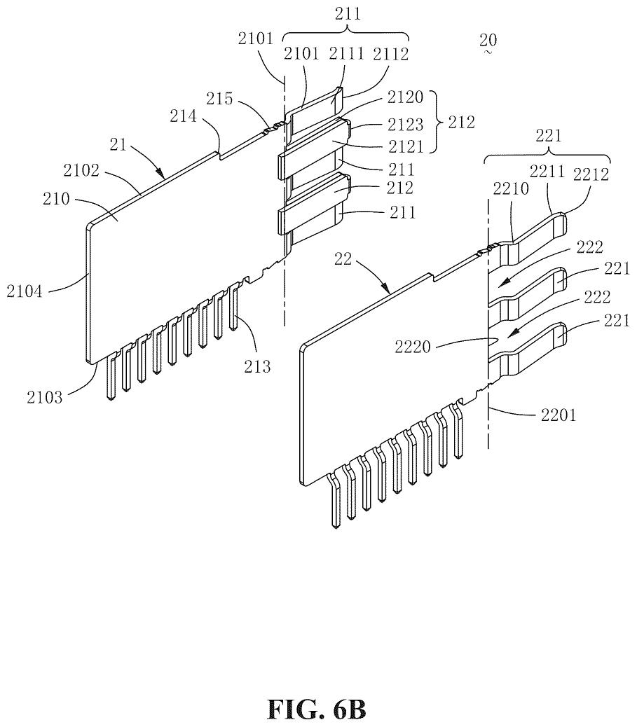

Please refer to FIGS. 6A and 6B, in the embodiment, the first body 210 of the first power terminal 21 is a vertical plate. In addition to the first mating side 2101, the first body 210 further has a first retaining side 2102, a first mounting side 2103, and a first tail side 2104. The first mating side 2101 is arranged parallel to the first tail side 2104, the first retaining side 2102 is arranged parallel to the first mounting side 2103, and the first retaining side 2102 and the first mounting side 2103 are perpendicular to the first mating side 2101. More specifically, in the embodiment, a vertical front edge of the first body 210 is served as the first mating side 2101, a vertical rear edge of the first body 210 is served as the first tail side 2104, a horizontal upper edge of the first body 210 is served as the first retaining side 2102, and a horizontal lower edge of the first body 210 is served as the first mounting side 2103.

Referring to FIGS. 6A and 6B, on the first mating side 2101, the first bent inclined beam 211 has a first expansion portion 2110, a first contact portion 2111, and a first guide portion 2112. The first expansion portion 2110 is connected to the first mating side 2101, and is formed by being first bent in a direction away from the second power terminal 22 and then being bent in a direction close to the second power terminal 22. The first contact portion 2111 is far away from the first mating side 2101, and is formed by being bent in a direction away from the second power terminal 22. The first guide portion 2112 is located at a free end of the first bent inclined beam 211, extending in a direction away from the second power terminal 22.

Referring to FIGS. 6A and 6B, on the first mating side 2101, the folded straight beam 212 has a first straight portion 2120, a second straight portion 2121 folded on the first straight portion 2120, and a folded portion 2123 connecting the first straight portion 2120 and the second straight portion 2121. More specifically, One end of the first straight portion 2120 is connected to the first mating side 2101, and the other end thereof is connected to the folded portion 2123. One end of the second straight portion 2121 is connected to the folded portion 2123, and the other end thereof is a free end.

Specifically, the folded straight beam 212 is made by a folding process to form the first straight portion 2120, the second straight portion 2121, and the folded portion 2123. The folded portion 2123 is a similar cylindrical body with an arc cross-section. It should be noted that the so-called folding process refers to a 180 degree bending process or a bending process close to 180 degrees. In fact, due to the influence of the bending process or terminal material, after folding, the first straight portion 2120 and the second straight portion 2121 are not completely parallel, but are generally folded. The cross-section of the folding portion 2123 described in the present application may be nearly semi-circular. In fact, as long as the folded portion 2123 can make the first straight portion 2120 and the second straight portion 2121 roughly be folded together, the folded straight beam 212 has the function of safe engaging.

The present application can ensure that the folded straight beam 212 is safely inserted into the mating terminal assembly 60 by providing the folded portion 2123 at a front end of the folded straight beam 212, thereby achieving safe engaging.

In the embodiment, a length of the second straight portion 2121 is greater than a length of the first straight portion 2120. Therefore, the free end of the second straight portion 2121 extends backward, exceeds the first straight portion 2120, and adheres to one side of the first body 210 facing the second power terminal 22.

In the embodiment, the first power terminal 21 includes multiple of the first bent inclined beams 211 and multiple of the folded straight beams 212 (e.g., three first bent inclined beams 211 and two folded straight beams 212), which are alternately arranged. The present application does not limit the specific number of the first bent inclined beam 211 and the folded straight beam 212.

Moreover, referring to FIGS. 6A and 6B, the first power terminal 21 further includes multiple of pins 213 arranged in a row. In the embodiment, the pins 213 are disposed on the first mounting side 2103 and extend downward for being mounted to a circuit board (not shown). The first power terminal 21 further includes a retaining structure for retaining the first power terminal 21 to the insulation base 10. The retaining structure may include a shoulder 214 provided on the first retaining side 2102, and multiple of protrusions 215 provided on the first retaining side 2102 and the first mounting side 2103.

Please refer to FIGS. 6A and 6B, in the embodiment, one main difference between the second power terminal 22 and the first power terminal 21 is that the second power terminal 22 does not have the folded straight beam 212.

Specifically, the second body 220 of the second power terminal 22 is also a vertical plate. In addition to the second mating side 2201, the second body 220 further has a second retaining side 2202, a second mounting side 2203, and a second tail side 2204. The second mating side 2201 is arranged parallel to the second tail side 2204, the second retaining side 2202 is arranged parallel to the second mounting side 2203, and the second retaining side 2202 and the second mounting side 2203 are perpendicular to the second mating side 2201.

On the second mating side 2201, the second bent inclined beam 221 has a second expansion portion 2210, a second contact portion 2211, and a second guide portion 2212. The second expansion portion 2210 is connected to the second mating side 2201, and is formed by being first bent in a direction away from the first power terminal 21 and then being bent in a direction close to the first power terminal 21. The second contact portion 2211 is far away from the second mating side 2201, and is formed by being bent in a direction away from the first power terminal 21. The second guide portion 2212 is located at a free end of the second bent inclined beam 221, extending in a direction away from the first power terminal 21.

Referring to FIGS. 6A and 6B, the second power terminal 22 further includes at least one blank region 222 provided on the second mating side 2201. The blank region 222 corresponds to the folded straight beam 212 of the first power terminal 21 and is used to accommodate a part of the folded straight beam 212, such as the second straight portion 2121 of the folded straight beam 212. The depth of the blank region 222 can be determined according to the length of the second straight portion 2121. Specifically, when the first power terminal 21 and the second power terminal 22 are combined together, the second straight portion 2121 is located in the blank region 222, and the free end of the second straight portion 2121 is connected to one edge 2220 of the blank region 222. Specifically, the blank region 222 can be square, and its side 2220 is a vertical edge. The blank region 222 can also be arc-shaped, and its side 2220 is an arc edge. Of course, the side 2220 of the blank region 222 can be directly served by a vertical front edge of the second body 220. Namely, it is not necessary to concave inward at the vertical front edge of the second body 220 to form the side 2220.

In the embodiment, because the free end of the second straight portion 2121 of the first power terminal 21 is approximately square, the blank region 222 is set as a square region 222 with a vertical edge, so that the both can match.

The present application can increase the rigidity of the folded straight beam 212, improve its mating strength, prevent the folded straight beam 212 from deviating during mating, and further improve the mating safety of the folded straight beam 212 by aligning the second straight portion 2121 of the first power terminal 21 with the blank region 222 of the second power terminal 22. In addition, by connecting the second straight portion 2121 to the edge 2220, the current transmission capability of the first power terminal 21 and the second power terminal 22 can be further improved.

In other embodiments, the length of the second straight portion 2121 may be equal to the length of the first straight portion 2120, but it is necessary to ensure that the free end of the second straight portion 2121 is connected to the edge 2220 of the blank region 222 in order to improve the mating strength of the folded straight beam 212. It should also be noted that, for the sake of mating safety, the length of the second straight portion 2121 should not be less than (but can be slightly less than) the length of the first straight portion 2120, to ensure that the second straight portion 2121 has a sufficiently long electrical contact region or a sufficiently large contact area when mating with the mating terminal assembly 60.

In the embodiment, the second power terminal 22 includes multiple of the second bent inclined beams 221 and multiple of the blank regions 222 (e.g., three second bent inclined beams 221 and two blank regions 222), which are alternately arranged and are corresponding to multiple of the first bent inclined beams 211 and multiple of the folded straight beams 212. The present application does not limit the specific number of the second bent inclined beam 221 and the blank region 222.

Moreover, as shown in FIGS. 6A and 6B, the second power terminal 22 further has a similar structure to the first power terminal 21. For example, the second power terminal 22 also includes multiple of pins 223, a retaining structure, etc.

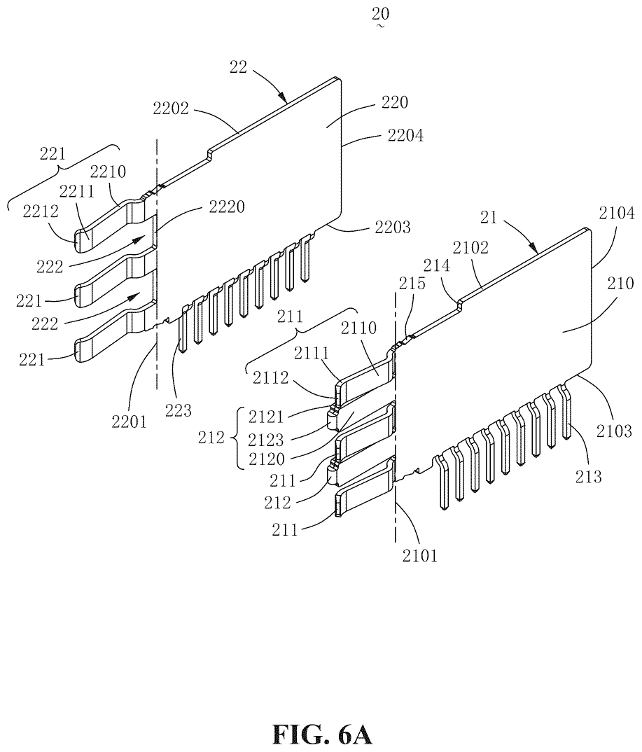

Please refer to FIGS. 4 and 5, when the first power terminal 21 and the second power terminal 22 are combined together, the first body 210 and the second body 220 are in parallel touch each other. The first bent inclined beam 211 and the second bent inclined beam 221 face each other to form a pair of clamping beams, while the folded straight beam 212 is used as an insertion beam, and the second straight portion 2121 is located in the blank region 222.

In this embodiment, the first power terminal 21 and the second power terminal 22 together form three pairs of clamping beams and two insertion beams, which are alternately arranged to transmit power together.

More specifically, the first mating side 2101, the first retaining side 2102, the first mounting side 2103, and the first tail side 2104 of the first body 210 are aligned with the second mating side 2201, the second retaining side 2202, the second mounting side 2203, and the second tail side 2204 of the second body 220, respectively. The first expansion portion 2110, the first contact portion 2111, and the first guide portion 2112 of the first bent inclined beam 211 are aligned with the second expansion portion 2210, the second contact portion 2211, and the second guide portion 2212 of the second bent inclined beam 221, respectively. An insertion space 201 (seen in FIG. 4) is formed between the first expansion portion 2110 and the second expansion portion 2210 to accommodate the inserted mating terminal assembly 60. An elastic clamping port 202 (seen in FIG. 4) is formed between the first contact portion 2111 and the second contact portion 2211 to provide elastic clamping and electrical contact functions. For example, the elastic clamping port 202 is able to elastically clamp the mating terminal assembly 60 and electrically contact with the mating terminal assembly 60. A guide port 203 (seen in FIG. 4) is formed between the first guide portion 2112 and the second guide portion 2212 to provide guidance. For example, the guide port 203 is able to guide the mating terminal assembly 60 into the elastic clamping port 202. A width of the guide port 203 is greater than a width of the elastic clamping port 202.

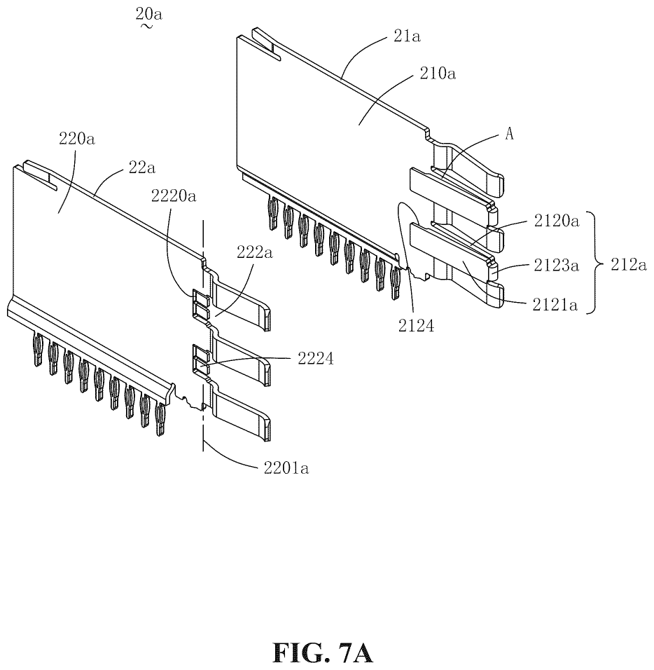

The following will introduce another embodiment of a power terminal assembly 20a of the present application as shown in FIGS. 7A, 7B and 7C. The power terminal assembly 20a of FIGS. 7A, 7B and 7C is alike to the power terminal assembly 20 of FIGS. 6A and 6B. Like elements or structures of the power terminal assembly 20a with the power terminal assembly 20 share the same reference numerals with the addition of the suffix “a”.

Please refer to a first power terminal 21a shown in FIG. 7A, a folded straight beam 212a forms a first straight portion 2120a, a second straight portion 2121a, and a folded portion 2123a through a folding process. The first straight portion 2120a and the second straight portion 2121a are not completely parallel, and there is an angle A between them. In addition, the second straight portion 2121a is provided with a power connection section 2124, which is located at a free end or in a region adjacent to the free end of the second straight portion 2121a. A thickness of the power connection section 2124 is smaller than a thickness of other regions of the second straight portion 2121a. More specifically, at one side of the free end of the second straight portion 2121a or the region adjacent to the free end, which faces a first body 210a of the first power terminal 21a, it is thinned to form the power connection section 2124. Therefore, the power connection section 2124 can be referred to as a thinning section.

Please refer to a second power terminal 22a shown in FIG. 7A. A blank region 222a is provided with at least one power connection sheet 2224. The power connection sheet 2224 protrudes forward from one edge 2220a of the blank area 222a in a direction approximately perpendicular to a second mating side 2201a. In fact, the power connection sheet 2224 is slightly tilted toward a second body 220a and tilted toward the first power terminal 21a, in order to form a reliable connection with the power connection section 2124. A thickness of the power connection sheet 2224 is smaller than a thickness of the second body 220a of the second power terminal 22a. Therefore, the power connection sheet 2224 can be referred to as a thinning sheet. In this embodiment, the power connection sheet 2224 and the second body 220a are integrally manufactured.

Please refer to FIG. 7B, when the first power terminal 21a and the second power terminal 22a are combined together, the power connection section 2124 faces the power connection sheet 2224.

Please refer to FIG. 7C, when the power terminal assembly 20a is engaged with a mating terminal assembly (not shown), the folded straight beam 212a will be subjected to a clamping force from the mating terminal assembly, and the power connection section 2124 will move toward the power connection sheet 2224 along with the second straight portion 2121a and eventually connect to the power connection sheet 2224. That is, the power connection section 2124 is attached to the power connection sheet 2224. In this way, the second straight portion 2121a is directly connected to the second power terminal 22a, thereby improving power transmission efficiency. In addition, due to the thinning design of the power connection section 2124 and the power connection sheet 2224, it can not only improve the stability of the combination between the power connection section 2124 and the power connection sheet 2224, but also can not increase the total thickness of the first power terminal 21a and the second power terminal 22a after combined.

Please refer to FIGS. 1, 2 and 3, in the embodiment, the power connector 1 of the present application includes multiple of power terminal assemblies 20, such as four power terminal assemblies 20 arranged side by side.

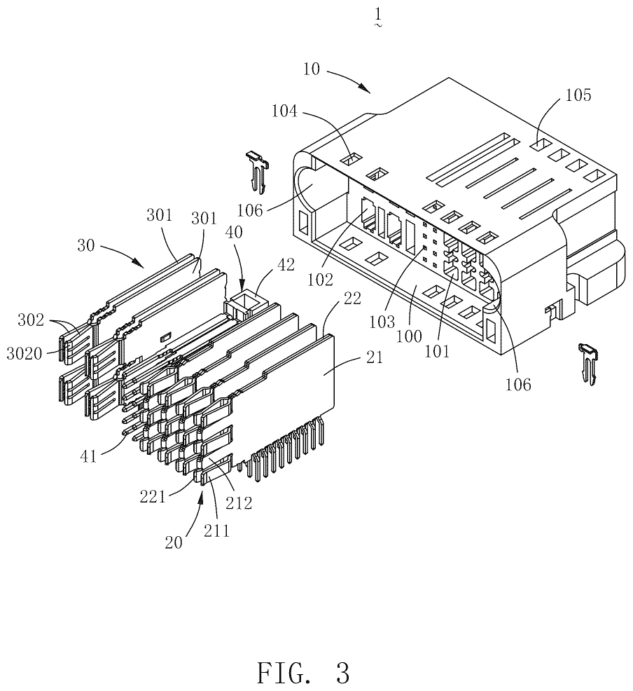

The power connector 1 of the present application further includes multiple of other power terminal assemblies. If the above power terminal assembly 20 is referred to as a first type power terminal assembly 20, then the other power terminal assemblies can be referred to as a second type power terminal assembly 30, which has a structure different from the first type power terminal assembly 20. In detail, as shown in FIG. 3, each second type power terminal assembly 30 includes two power terminals 301 symmetrically arranged, and multiple pairs of elastic beams 302 are formed at front ends of the two power terminals 301. Each the pair of elastic beams 302 has a pair of external contact portions 3020 facing away from each other.

The power connector 1 of the present application further includes a signal terminal module 40. The signal terminal module 40 includes multiple of signal terminals 41 arranged in at least one column and a fixing seat 42 for fixing the signal terminals 41.

In this embodiment, as shown in FIG. 3, the first type power terminal assembly 20 and the second type power terminal assembly 30 are respectively arranged on both sides of the signal terminal module 40.

Please refer to FIG. 3, the insulation base 10 includes a mating interface 100 and three groups of terminal channels 101, 102 and 103. The mating interface 100 is located at a front end of the insulation base 10, and the three groups of terminal channels 101, 102 and 103 pass through the mating interface 100, a rear surface of the insulation base 10, and a bottom surface of the insulation base 10. The three groups of terminal channels 101, 102 and 103 are used to respectively accommodate and fix the first type power terminal assembly 20, the second type power terminal assembly 30 and the signal terminal 41. Wherein, the clamping beams (i.e. the first bent inclined beam 211 and the second bent inclined beam 221) and the insertion beam (i.e. the folded straight beam 212) of the first type power terminal assembly 20, the elastic beams 302 of the second type power terminal assembly 30, and a front mating section 410 of the signal terminal 41 all enter into the mating interface 100. The pins 213 and 223 of the first type power terminal assembly 20, pins of the second type power terminal assembly 30, and pins of the signal terminal 41 all protrude from the bottom surface of the insulating base 10. The first type power terminal assembly 20 and the second type power terminal assembly 30 are both locked in the insulating base 10 through their respective retaining structures. And the signal terminal 41 is fixed in the insulating base 10 by the fixing seat 42.

It should be noted that the first power terminal 21 and the second power terminal 22 can be combined by being assembled together in the corresponding terminal channel 101 of the insulating base 10 and clamped by side walls of the terminal channel 101. Alternatively, the first power terminal 21 and the second power terminal 22 are provided with mutual locking structures to further improve stability.

In addition, as shown in FIG. 3, the insulation base 10 of the present application is also provided with multiple of first heat dissipation holes 104 and multiple of second heat dissipation holes 105. The first heat dissipation holes 104 are distributed on the top and bottom surfaces of the insulation base 10 and correspond to a position of the mating interface 100 for being communicated with the mating interface 100. The second heat dissipation holes 105 are distributed on the top surface of the insulation base 10, and are located near the rear surface. The insulation base 10 of the present application is also provided with two symmetrical guide passages 106 distributed on both sides of the mating interface 100 for guiding the mating connector 2 to be accurately inserted into the mating interface 100.

The structure and advantages of the mating connector 2 and the connector assembly 3 of the present application will be described in detail below.

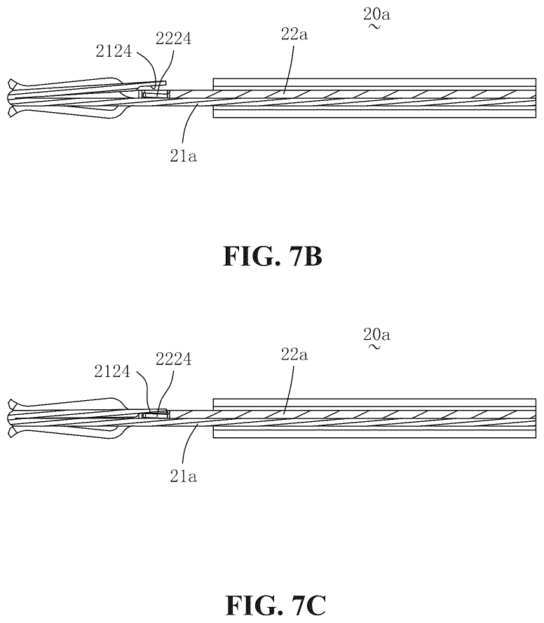

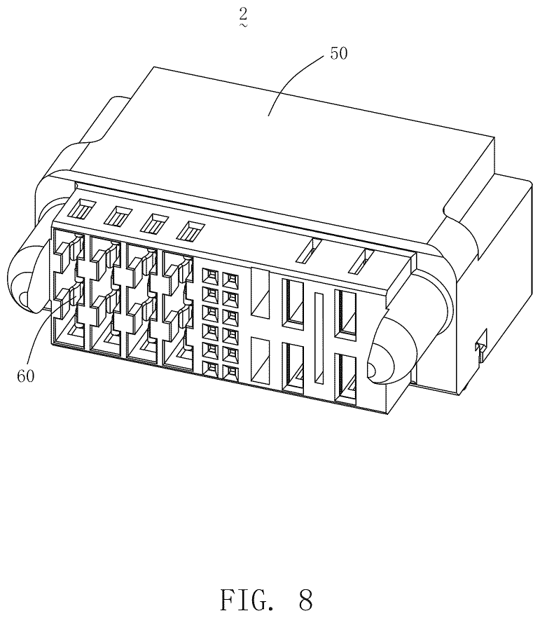

Please refer to FIGS. 8, 9 and 10, the mating connector 2 of the present application includes a mating base 50 and at least one mating terminal assembly 60 disposed in the mating base 50. Wherein, the mating terminal assembly 60 includes a third power terminal 61 and a fourth power terminal 62 combined to transmit power together.

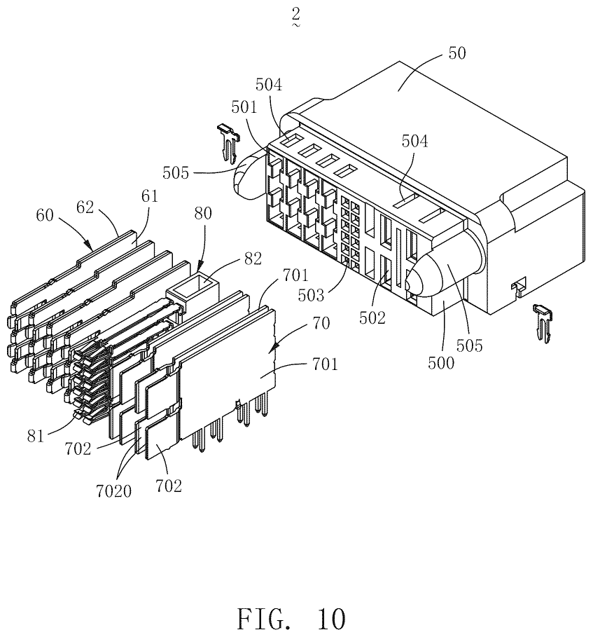

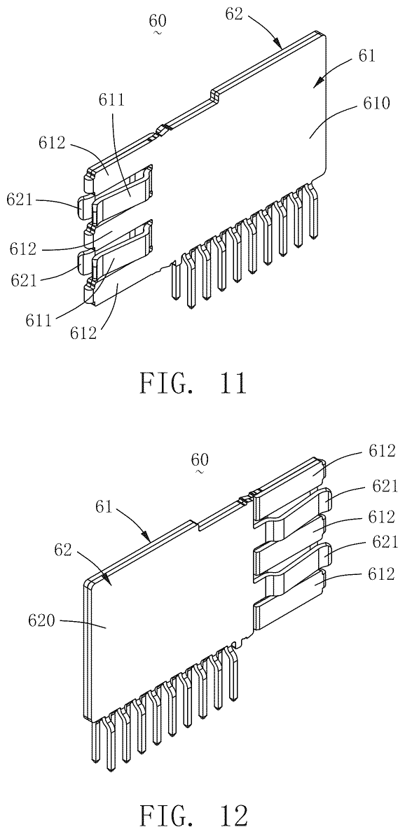

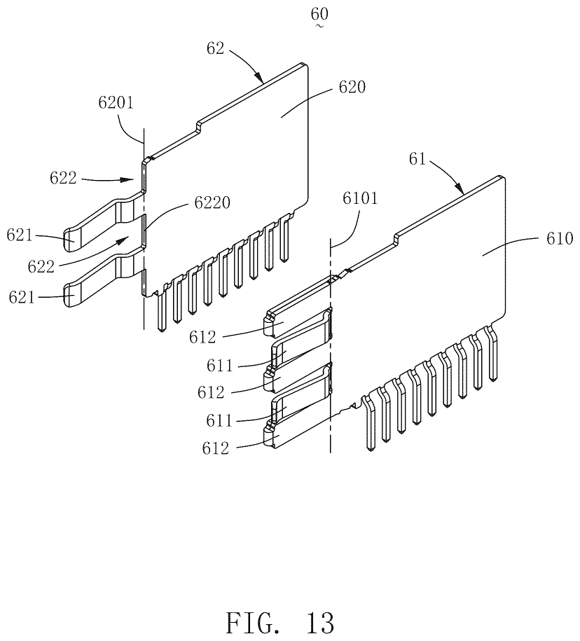

Please refer to FIGS. 11, 12 and 13, the third power terminal 61 includes a third body 610 with a third mating side 6101, at least one third bent inclined beam 611 disposed on the third mating side 6101, and at least one folded straight beam 612 disposed on the third mating side 6101. The fourth power terminal 62 includes a fourth body 620 with a fourth mating side 6201, at least one fourth bent inclined beam 621 disposed on the fourth mating side 6201, and at least one blank region 622 located on the fourth mating side 6201 (seen in FIG. 13). The third body 610 and the fourth body 620 are parallel and touch each other. The third bent inclined beam 611 and the fourth bent inclined beam 621 are arranged opposite each other to form a pair of clamping beams, while the folded straight beam 612 forms an insertion beam. The folded straight beam 612 corresponds to the blank region 622, and a part of the folded straight beam 612 is accommodated in the blank region 622 and connected to an edge 6220 of the blank area 622.

From the above description, it can be seen that the mating terminal assembly 60 has a similar structure to the power terminal assembly 20. For example, the folded straight beam 612 of the mating terminal assembly 60 is similar to the folded straight beam 212 of the power terminal assembly 20, and the third bent inclined beam 611 and the fourth bent inclined beam 621 of the mating terminal assembly 60 are similar to the first bent inclined beam 211 and the second bent inclined beam 221 of the power terminal assembly 20, respectively.

A main difference between the mating terminal assembly 60 and the power terminal assembly 20 is that: the pair of clamping beams and the insertion beams are different in positions and quantities, in order to be matched during engaging. For example, in this embodiment, the power terminal assembly 20 is provided with three pairs of clamping beams and two insertion beams, and correspondingly, the mating terminal assembly 60 is provided with three insertion beams and two pairs of clamping beams.

Of course, in other embodiments, the mating terminal assembly 60 may also have a similar structure to the power terminal assembly 20a. Here will be not further elaborated.

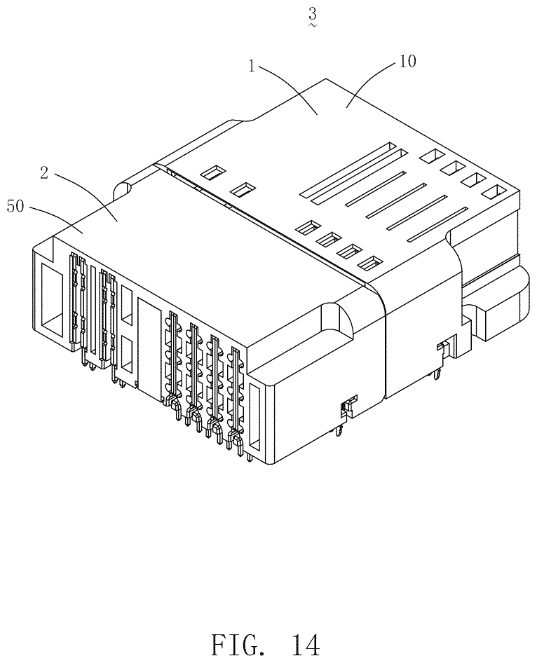

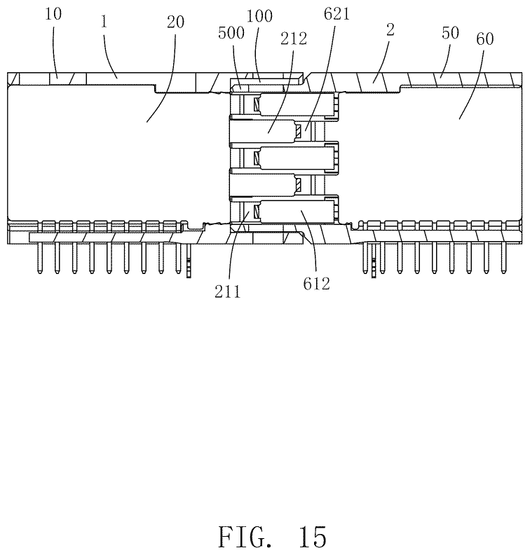

Please refer to the connector assembly 3 shown in FIGS. 14 and 15. When the power connector 1 is engaged with the mating connector 2, the insertion beam (that is, the folded straight beam 212) of the power terminal assembly 20 is inserted between the pair of clamping beams (that is, the third bent inclined beam 611 and the fourth bent inclined beam 621) of the mating terminal assembly 60 to form an electrical connection, while the insertion beam (that is, the folded straight beam 612) of the mating terminal assembly 60 is inserted between the pair of clamping beams (that is, the first bent inclined beam 211 and the second bent inclined beam 221) of the power terminal assembly 20 to form an electrical conduction, thereby transmitting power together.

Please refer to FIG. 10 again. In this embodiment, the mating connector 2 of the present application includes multiple of the mating terminal assemblies 60, for example, four mating terminal assemblies 60 arranged side by side.

The mating connector 2 of the present application further includes multiple of other mating terminal assemblies. If the above mating terminal assembly 60 is referred to as a third type power terminal assembly 60, then the other mating terminal assemblies can be referred to as a fourth type power terminal assembly 70, which has a structure different from the third type power terminal assembly 60. In detail, as shown in FIG. 10, each fourth type power terminal assembly 70 includes two mating terminals 701 symmetrically arranged. The two mating terminals 701 form multiple pairs of blade beams 702 at front ends of the two mating terminals 701. Each the pair of blade beams 702 has a pair of internal contact portions 7020 facing each other.

The mating connector 2 of the present application further includes a mating signal terminal module 80 arranged between the third type power terminal assembly 60 and the fourth type power terminal assembly 70. The mating signal terminal module 80 includes multiple of mating signal terminals 81 arranged in at least one column and a mating fixing seat 82 for fixing the mating signal terminals 81.

In addition, the mating base 50 is also provided with an insertion section 500 located at a front end of the mating base 50 and three groups of mating terminal channels 501, 502, 503. The mating terminal channels 501, 502, 503 pass through a front surface of the insertion section 500, a rear surface of the mating base 50, and a bottom surface of the mating base 50 for accommodating and fixing the third type power terminal assembly 60, the fourth type power terminal assembly 70 and the mating signal terminal 81, respectively.

When the power connector 1 and the mating connector 2 are engaged together, as shown in FIG. 15, the insertion section 500 of the mating base 50 enters into the mating interface 100 of the insulating base 10, and the clamping beams and the insertion beam of the first type power terminal assembly 20 are respectively engaged with the insertion beam and the clamping beam of the third type power terminal assembly 60 to form an electrical connection for transmitting power. In addition, the elastic beams 302 (especially the external contact portions 3020 of the elastic beams) of the second type power terminal assembly 30 are connected to the blade beams 702 (especially the internal contact portions 7020 of the blade beams 702) of the fourth type power terminal assembly 70 to form an electrical connection for transmitting power. And the signal terminal 41 and the mating signal terminal 81 form an electrical connection for transmitting signals.

Please refer to FIG. 10 again, the mating base 50 of the present application is further provided with multiple of third heat dissipation holes 504, which are distributed on the top and bottom surfaces of the insertion section 500 and pass through the mating terminal channels 501, 502. The mating base 50 is also provided with two symmetrical guide posts 505, which are distributed on both sides of the insertion section 500 and can guide the mating connector 2 to accurately insert into the mating interface 100.

In summary, the power connector 1 and the connector assembly 3 of the present application can avoid the risk of unsafe engagement by employing the folded straight beams 212 and 612 as the insertion beams in the power terminal assembly 20 and the mating terminal assembly 60. The connector assembly 3 of the present application has a stable and safe engaging structure, can provide stable current conduction capability and can improve service life.

It should be understood that, the application of the present application is not limited to the above examples listed. Ordinary technical personnel in this field can improve or change the applications according to the above descriptions, all of these improvements and transforms should belong to the scope of protection in the appended claims of the present application.

What is claimed is:

1. A power connector, comprising an insulation base and at least one power terminal assembly disposed in the insulation base; the power terminal assembly comprising a first power terminal and a second power terminal combined together;
the first power terminal comprising a first body with a first mating side, at least one first bent inclined beam disposed on the first mating side, and at least one folded straight beam disposed on the first mating side; and
the second power terminal comprising a second body with a second mating side and at least one second bent inclined beam disposed on the second mating side;
wherein, the first body and the second body are in parallel touch each other and are fixed together in the insulation base; the first bent inclined beam and the second bent inclined beam are arranged opposite each other to form a pair of clamping beams, and the folded straight beam is used as one insertion beam.

2. The power connector according to claim 1, wherein the first bent inclined beam has a first expansion portion, a first contact portion and a first guide portion; wherein the first expansion portion is connected to the first mating side, the first contact portion is far away from the first mating side, and the first guide portion is located at a free end of the first bent inclined beam;
the second bent inclined beam has a second expansion portion, a second contact portion and a second guide portion; wherein the second expansion portion is connected to the second mating side, the second contact portion is far away from the second mating side, and the second guide portion is located at a free end of the second bent inclined beam;
the power terminal assembly forms an insertion space between the first expansion portion and the second expansion portion for accommodating a mating terminal assembly of a mating connector;
the power terminal assembly forms an elastic clamping port between the first contact portion and the second contact portion for clamping and electrically contacting with the mating terminal assembly; and
the power terminal assembly forms a guide port between the first guide portion and the second guide portion for guiding the mating terminal assembly into the elastic clamping port.

3. The power connector according to claim 1, wherein the folded straight beam has a first straight portion, a second straight portion folded on the first straight portion, and a folded portion connecting the first straight portion and the second straight portion; wherein, one end of the first straight portion is connected to the first mating side, and the other end of the first straight portion is connected to the folded portion; one end of the second straight portion is connected to the folded portion, and the other end of the second straight portion is a free end.

4. The power connector according to claim 3, wherein a length of the second straight portion is greater than or equal to a length of the first straight portion.

5. The power connector according to claim 3, wherein the second power terminal comprises at least one blank region provided on the second mating side; and
the second straight portion is located in the blank region, and the free end of the second straight portion is connected to one edge of the blank region.

6. The power connector according to claim 3, wherein the second straight portion is provided with a power connection section at a free end of the second straight portion;
a thickness of the power connection section is smaller than a thickness of the second straight portion; and
the second power terminal comprises at least one blank region provided on the second mating side; a blank region is provided with at least one power connection sheet;
and a thickness of the power connection sheet is smaller than a thickness of the second body;
wherein, the power connection section faces the power connection sheet; and
wherein, when the power terminal assembly is engaged with a mating terminal assembly, the power connection section is connected to the power connection sheet.

7. The power connector according to claim 5, wherein the first power terminal comprises multiple of the first bent inclined beams and multiple of the folded straight beams, which are alternately arranged; and
the second power terminal comprises multiple of the second bent inclined beams and multiple of the blank regions, which are alternately arranged.

8. A power terminal assembly, comprising a first power terminal and a second power terminal combined together;
the first power terminal comprising a first body with a first mating side, at least one first bent inclined beam disposed on the first mating side, and at least one folded straight beam disposed on the first mating side; and
the second power terminal comprising a second body with a second mating side, at least one second bent inclined beam disposed on the second mating side, and at least one blank region provided on the second mating side;
wherein, the first body and the second body are parallel and touch each other, the first bent inclined beam and the second bent inclined beam are arranged opposite each other to construct a pair of clamping beams, and the folded straight beam is used as one insertion beam; and
wherein, the folded straight beam is corresponding to the blank region, and a part of the folded straight beam is accommodated in the blank region.

9. The power terminal assembly according to claim 8, wherein the folded straight beam has a first straight portion, a second straight portion folded on the first straight portion, and a folded portion connecting the first straight portion and the second straight portion; a length of the second straight portion is greater than or equal to a length of the first straight portion;
one end of the first straight portion is connected to the first mating side, and the other end of the first straight portion is connected to the folded portion; one end of the second straight portion is connected to the folded portion, and the other end of the second straight portion is a free end;
the second straight portion is provided with a power connection section at the free end of the second straight portion; and
the blank region is provided with at least one power connection sheet;
wherein, the power connection section faces the power connection sheet; and
wherein, when the power terminal assembly is engaged with a mating terminal assembly, the power connection section is connected to the power connection sheet.

10. A connector assembly, comprising a power connector and a mating connector;
the power connector comprising an insulation base and at least one power terminal assembly disposed in the insulation base;
the mating connector comprising a mating base and at least one mating terminal assembly disposed in the mating base;
the power terminal assembly having a first bent inclined beam, a second bent inclined beam and a folded straight beam; wherein, the first bent inclined beam and the second bent inclined beam are arranged opposite each other to form a pair of clamping beams, while the folded straight beam is used as one insertion beam; and
the mating terminal assembly having a third bent inclined beam, a fourth bent inclined beam and a folded straight beam; wherein, the third bent inclined beam and the fourth bent inclined beam are arranged opposite each other to form a pair of clamping beams, while the folded straight beam is used as one insertion beam;
wherein, when the power connector and the mating connector are engaged, the insulation base is engaged with the mating base, the insertion beam of the power terminal assembly is inserted between the pair of clamping beams of the mating terminal assembly to form an electrical connection, and the insertion beam of the mating terminal assembly is inserted between the pair of clamping beams of the power terminal assembly to form an electrical connection, for transmitting power together.

11. The connector assembly according to claim 10, wherein the power terminal assembly comprises a first power terminal and a second power terminal combined together;
the first bent inclined beam and the folded straight beam of the power terminal assembly are disposed on the first power terminal;
the second bent inclined beam of the power terminal assembly is disposed on the second power terminal;
the mating terminal assembly comprises a third power terminal and a fourth power terminal combined together;
the third bent inclined beam and the folded straight beam of the mating terminal assembly are disposed on the third power terminal; and
the fourth bent inclined beam of the mating terminal assembly is disposed on the fourth power terminal.

12. The connector assembly according to claim 10, wherein the power connector comprises multiple of the power terminal assemblies, and the power terminal assembly is referred to as a first type power terminal assembly;
the power connector comprises multiple of second type power terminal assemblies, each of which is different from the first type power terminal assembly; wherein, the second type power terminal assembly has two symmetrically arranged power terminals, which form multiple pairs of elastic beams at front ends of the two power terminals; each the pair of elastic beams has a pair of external contact portions facing away from each other; and
the power connector comprises a signal terminal module, which comprises multiple of signal terminals arranged in at least one column and a fixing seat for fixing the signal terminals.

13. The connector assembly according to claim 12, wherein the mating terminal assembly comprises multiple of the mating terminal assemblies, and the mating terminal assembly is referred to as a third type power terminal assembly;
the mating terminal assembly comprises multiple of fourth type power terminal assemblies different from the third type power terminal assembly; wherein, the fourth type power terminal assembly comprises two mating terminals, which are symmetrically arranged and form multiple pairs of blade beams at front ends of the two mating terminals; each the pair of blade beams has a pair of internal contact portions facing each other; and
the mating terminal assembly comprises a mating signal terminal module, which comprises multiple of mating signal terminals arranged in at least one column and a mating fixing seat for fixing the mating signal terminals.

14. The connector assembly according to claim 13, wherein the insulation base is provided with a mating interface at a front end of the insulation base;
the mating base is provided with an insertion section at a front end of the mating base;
when the power connector and the mating connector are engaged, the insertion section enters into the mating interface;
the clamping beams and the insertion beam of the first type power terminal assembly are respectively engaged with the insertion beam and the clamping beams of the third type power terminal assembly to form the electrical connection for transmitting the power;
the external contact portions of the elastic beams of the second type power terminal assembly are engaged with the internal contact portions of the blade beams of the fourth type power terminal assembly to form an electrical connection for transmitting power; and
the signal terminals are engaged with the mating terminals for transmitting signals.
